(19) United States
(12) Patent Application Publication
(10) Pub. No.: US 2008/0165398 A1
(43) Pub. Date: Jul. 10, 2008

(54) Security Display Assembly

(75) Inventors: Henri Jagt, Eindhoven (NL); Peter Jan Slikkerveer, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/994,419

(22) PCT Filed: Jun. 28, 2006
(86) PCT No.: PCT/IB2006/052157

§ 371 Date: Jan. 2, 2008

(30) Foreign Application Priority Data
Jul. 5, 2005 (EP) 05106063.0

(51) Int. Cl. G02B 5/32

(52) U.S. Cl. 359/2

(57) ABSTRACT

The present invention relates to a security display assembly (10; 50) comprising a display (12; 52) for providing a display image and a hologram (14; 54) for providing a holographic image. The hologram is integrated into the display and occupies essentially the same or less area as the display. Integrating the hologram into the display makes counterfeiting of a product provided with the security display assembly more difficult. It also saves space on the product onto which the security display assembly is provided. The invention also relates to a smart card (20) comprising such a security display assembly.

The present invention relates to a security display assembly, and a security product, such as a smart card, comprising such a security display assembly.

It is well known to provide items such as credit cards, driver's licenses, identification cards, etc., with security features in order to prevent counterfeiting. The security feature can for example be a hologram providing a holographic image, which hologram is provided on the surface of the item. At the same time, smart card technology is increasingly being used for credit cards, driver's licenses, identification cards, etc. Smart cards nowadays can further comprise displays, which displays are used for displaying a wide range of information content depending on the specific use of the smart card.

However, in a smart card, the available space is quite limited and the physical dimensions of the card are usually standardized. Integration of a display will therefore conflict with existing information and design of the card, and it may simply be difficult to find room on the smart card for all necessary items such as the display, an interface for controlling the display, the security feature, a smart card chip, logos and other printed information, etc. Further, it is relatively easily for anyone to attach a surface mounted hologram to/from an item, such as an identification card or credit card, in order to produce a counterfeit product.

It is an object of the present invention to overcome at least one of these problems, and to provide an improved security feature, which security feature in particular is suitable for use in connection with a smart card.

This and other objects that will be evident from the following description are achieved by means of a combined security feature and display (a ‘security display assembly’), and security product comprising such a security display assembly, according to the appended claims.

According to an aspect of the invention, there is provided a security display assembly, comprising a display for providing a display image and a hologram for providing a holographic image, wherein the hologram is integrated into the display, and the hologram occupies essentially the same or less area as the display.

Integrating the hologram into the display makes it difficult to remove the hologram without damaging or destroying the hologram and/or display, which increases security. It also saves valuable space on the product to which the security display assembly is attached, especially on a smart card of standard credit card size. Further, it makes counterfeiting more difficult, simply because it is harder to integrate a hologram into a display than it is to just place a hologram some place else on the product, as in prior art.

When the hologram is integrated in the display, the hologram can be positioned inside the display, in the optical stack or layer structure of the display. Further, the hologram can cover essentially the entire area of the display, i.e. have the same size as the display, or cover part of the display area.

In one embodiment, the display and hologram are aligned, so that the displayed image and holographic image form a combined image. That is, an observer should experience the display image and holographic image as one complete image. The combined image gives increased security, since the user in an authentic device should see both the display image and the holographic image in the display. Also, the quality of the alignment will give validation of the authenticity of the product onto which the security display assembly is provided. It also offers advantages when it comes to presentation of information, for example the contents of the display image can be matched with the contents of the holographic image.

For the alignment to occur optimally at all relevant viewing angles, the distance between the hologram and the “image forming layer” or electro-optical active layer (e.g. the layer that changes in optical characteristics when driven electrically) of the display should be minimized. Therefore, in one embodiment, the hologram is positioned proximate to the image forming layer of the display, i.e. very near the image forming layer of the display. An ‘image forming layer’ can for example be the liquid crystal layer in a liquid crystal display. Preferably, the distance between the hologram and the image forming layer is equal to or less than the size of a display element. The display element can for example be a pixel, a segment, an icon, etc. The distance between the hologram and the image forming layer could for instance be equal to 10%-70% of the size of the display element

In another embodiment, the security display assembly further comprises a holographic layer adapted to focus light incoming towards the layer in a predetermined range and direction. In that way, the brightness of the display, in a certain direction, can be increased. Preferably, the holographic layer is adapted to increase the brightness of the display in a limited predetermined viewing range. Note, that in an electrophoretic display this is only possible when the diffracted light from the display is used as light to form the hologram, i.e. when a transmissive hologram is used. This increases the readability of the display within this viewing range. At the same time, the brightness will be decreased for other angles outside the viewing range. This reduces the readability of the display for any onlookers watching the display from outside the viewing range, which in turn increases the security of the security display assembly (especially for displays with Lambertian type of viewing, like electrophoretic displays, this is a significant advantage). For example, a person can check the balance on his banking smart card provided with the security display assembly without any onlookers standing beside him seeing the information on the security display assembly. Preferably, the holographic layer is integrated with the hologram providing the holographic image. That is, the hologram of the security display assembly provides both the holographic image and the brightness improvement function.

Preferably, the display of the security display assembly is a reflective display. Products where the security display assembly advantageously is incorporated, such as smart cards, usually are very low power products, making a reflective display suitable. In a reflective display, incident light (external light such as indoor illumination or sunlight) from the observer side is reflected by a reflector through the image forming layer back towards the observer or scattered by the electro-optical layer like in an electrophoretic display.

The hologram can be placed in front of the image forming layer of the display. That is, towards an observer watching the display. Alternatively, the hologram can be placed behind the image forming layer of the display.

The display in the security device can for example be a liquid crystal display (such as TN, STN, IPS, VAN, CTLC, bistable nematic, stratified LCD, etc.), an electrophoretic display (such as E-ink), an electrochromic display, an electroluminescent display (such as OLED), or an electrowetting display.

According to another aspect of the invention, there is provided a security product, such as a smart card, comprising a security display assembly according to the above description. This security product offers similar advantages as obtained with the previously discussed aspect of the invention. For example when the hologram is integrated into the display, the hologram is positioned in essentially the same area on the security product as the display, taking up little space on the surface of the product.

These and other aspects of the present invention will now be described in more detail, with reference to the appended drawings showing currently preferred embodiments of the invention.

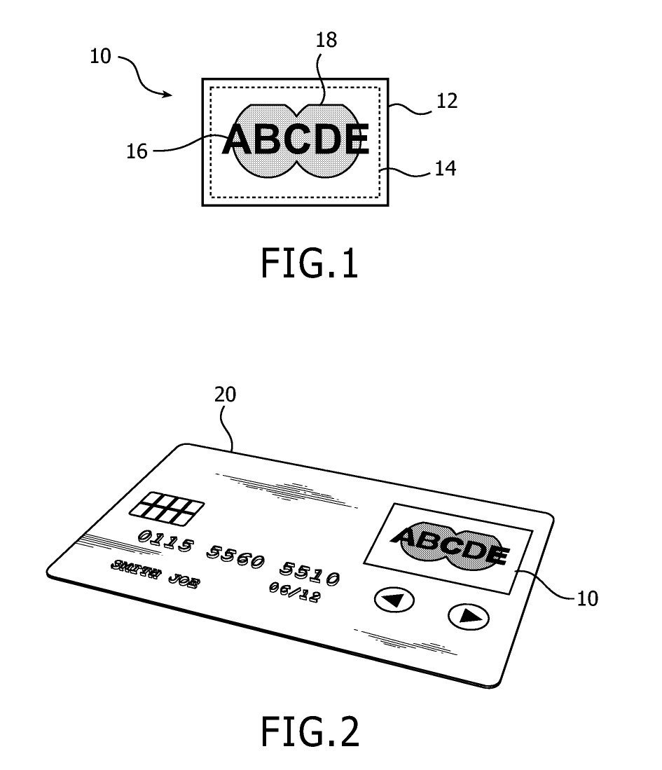

FIG. 1 is a front view of a security display assembly according to an embodiment of the invention;

FIG. 2 illustrates a smart card comprising a security display assembly according to the invention;

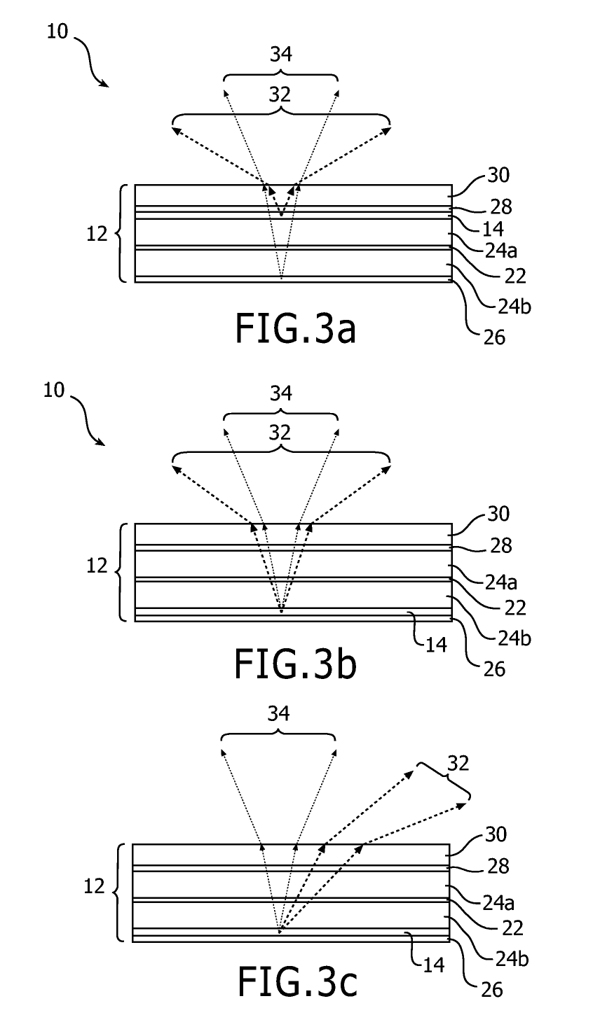

FIGS. 3a-3c illustrate schematically in cross-section a security display assembly comprising a liquid crystal display;

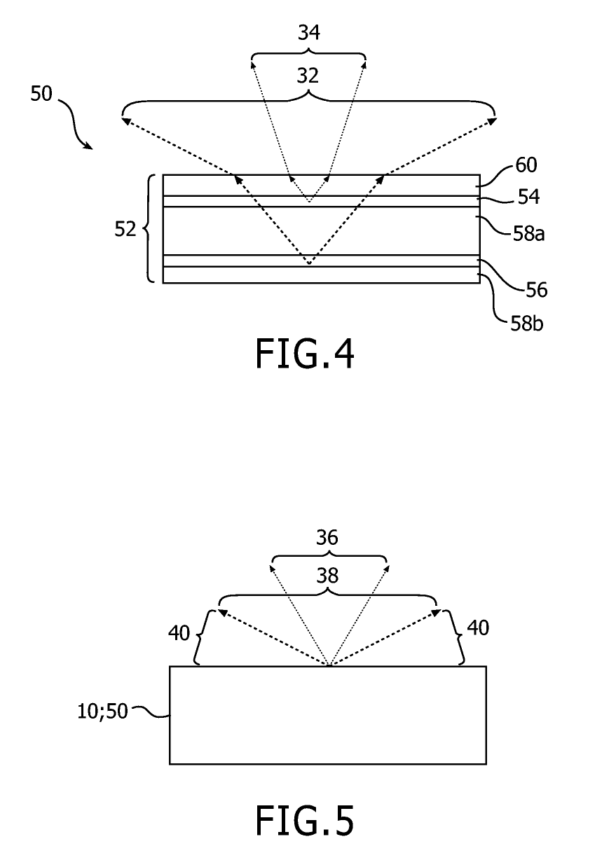

FIG. 4 is a schematic cross-sectional view of a security display assembly comprising an electrophoretic display; and

FIG. 5 illustrates schematically the output of a security display assembly according to another embodiment of the invention.

FIG. 1 is a front view of a security display assembly 10 according to an embodiment of the invention. The security display assembly 10 comprises a display 12 and a hologram 14, which hologram is integrated into the display. Since the hologram 14 is integrated in the display 12 and not extends outside the area of the display, it does not takes up unnecessary space on the product it is provided on.

In FIG. 1, the display 12 generates a text 16, while the hologram 14 provides a symbol 18 in the form of a holographic image. By placing the hologram close to the image forming layer of the display, and aligning the hologram with respect to the active area of the display, a combined image is formed, as shown in FIG. 1. That is, in FIG. 1, the display image and the holographic image are superimposed.

In case of for example a logotype with both text and symbol(s), the display image and the holographic image together form the complete logotype, as in FIG. 1. There are however various other combinations of display images and holographic images that can be utilized. For example, icons displayed by the display can be emphasized by a corresponding holographic image.

FIG. 2 illustrates a smart card 20 comprising a security display assembly 10 according to the invention. The smart card 20 is preferably of standard credit card size, and the security display assembly 10 comprises a display and an integrated hologram, as above. When the hologram is integrated into the display, the hologram is positioned in essentially the same area on the surface of the smart card as the display, whereby valuable space is saved on the smart card. Further, any display image or text that interacts with the holographic image may be securely stored in the smart card processor. The smart card can be programmed such that, for instance, on the start-up and/or the shut down of the smart card, and/or the pressing on a button or combination of buttons, the display text, that supplements the holographic image, will become visible.

FIG. 3a is a schematic cross-sectional view of a security display assembly 10 comprising an STN liquid crystal display 12. The display 12 comprises a liquid crystal layer 22, which constitutes the main image forming layer of the display. The liquid crystal layer 22 is interposed between display substrates 24a and 24b. Behind the substrate 24b, there is provided a metallized reflector 26, and in front of the substrate 24a, there is provided a retarder 28, as well as, in front of a retarder 28, a polarizer 30. These elements form part of a standard reflective liquid crystal display known to those skilled in the art.

The security display assembly 10 further comprises a hologram 14. The hologram 14 is placed inside the display, interposed between the retarder 28 and the display substrate 24a. Thus, in FIG. 3a, the hologram 14 is positioned in front of the liquid crystal layer 22, between the liquid crystal layer 22 and an observer. The hologram 14 in FIG. 3a is a transparent holographic film which has a reflective holographic reconstruction, i.e. a reflective hologram.

Upon operation of the security display assembly 10, a part of light externally incident on the display is diffracted towards the same side as the incident light by the reflective hologram 14, whereby the hologram 14 provides a holographic image as indicated by the holographic view cone 32. The part of the incident light that is not diffracted by the hologram is part of the usual optical pathway of the display 12, whereby the display 12 provides a display image as indicated by the dominant display viewing cone 34.

FIG. 3b is a schematic cross-sectional view of a security display assembly 10 according to another embodiment of the invention. The security display assembly of FIG. 3b is similar to one of FIG. 3a, except in that the hologram is positioned behind the liquid crystal layer 22, i.e. at the back of the display structure, between the substrate 24b and the metallized reflector 26. It should be noted that the hologram and reflector could be integrated, thus forming a holographic reflector.

Further, the holographic image and the display image can be superimposed, as illustrated in for example FIG. 3b. However, the holographic image can be tuned to be visible at specific viewing angles. Thus, it is possible to direct the holographic image 32 in a direction which is different from the dominant viewing direction 34 of the display image. This enables visual separation of the holographic image and the display image, an example of which is illustrated in FIG. 3c.

As such the light diffracted by the hologram has a different pathway than the non-diffracted light in the security display assembly. In FIG. 3a, the diffracted light is not entering towards the liquid crystal layer 22 and the substrates 24a and 24b, whereas in FIG. 3b, the diffracted light is not reflected at the metallized reflector 26.

Consequently, the polarization state of the diffracted light can, depending on the design, become different at the polarizer at the top of the display than the polarization state of the non-diffracted light. As a result, the holographic image can always be visible, even when the display image is black (where the non-diffracted light absorbed by the polarizer). The holographic image will be best visible on the dark state of the display. For instance, if the display is normally black (NB), the hologram will be easily visible when the display is turned off.

Alternatively by tuning the combination of hologram and state/switching effect of the electro-optical layer in the display, the visibility of the hologram can be tuned to the effect that it becomes more visible or less visible in the dark state of the display or in the bright state of the display. The variation obtained might be tuned from fully visible to (nearly) invisible.

For example, a polarization sensitive or polarization selective hologram can be used inside the optical path of a liquid crystal display. As mentioned above, in the dark state, the normally reflected light will be absorbed by the polarizer at the top of the display. The polarization sensitive or polarization selective hologram can however be adapted so that the light diffracted by the hologram has a certain polarization which differs from the light reflected not diffracted by the hologram. This diffracted light will therefore not be absorbed by the polarizer, and the holographic image will be clearly visible when the display image is dark. On the other hand, in the bright state of the display, the light incident on the hologram has a different polarization direction than the incident light on the hologram in the dark state of the display. The polarization selective hologram can be tuned not to diffract this light, so it is not changed in polarization direction. Consequently no holographic image is formed in the bright state of the display.

For interaction of the holographic image 18 with the display image 16, as shown in FIG. 1, an alignment of the hologram with the display is required. For this alignment to occur optimally at all relevant viewing angles, it is important to minimize the distance between the hologram and the image forming layer (the liquid crystal layer 22 in FIGS. 3a and 3b). Thus, the hologram should be positioned close to the image forming layer. Preferably, the distance between the hologram and the image forming layer is equal to or less than the size of an element of the display.

Further, in case of an LCD, if the display image, for example the text in FIG. 1, is bright, this light appears to come from the reflector at the back of the display. Therefore, in order to achieve best alignment, the hologram should be placed close to the reflector as in FIG. 3b. On the other hand, if the text is black on a white background, this text appears to be formed on the polarizer at the top of the display. Therefore, the hologram 14 should placed close to the polarizer as in FIG. 3a. In case the text is colored on a white background, black on a colored background or colored on a black background, the best location of the hologram is derived analogously.

As an alternative to the hologram having a reflective holographic reconstruction as in FIGS. 3a and 3b, a hologram having a transmissive holographic reconstruction, i.e. a transmissive hologram, could be used. If the hologram is a transmissive hologram, the diffracted light will travel through the display similarly (though at other angles) as the non-diffracted light. Therefore, this diffracted light will also be absorbed when the display is switched to its dark state. This enables superimposing of dark text on a white surrounding that also contains a holographic image. As such, the text readability (contrast) does not suffer from the additional holographic image. Also, this feature can be used to subtract information from the holographic image to provide a new holographic-non-holographic image combination.

FIG. 4 is a schematic cross-sectional view of a security display assembly 50 comprising an electrophoretic display 52. The display 52 comprises an electrophoretic medium layer 56, which constitutes the main image forming layer of the display. The electrophoretic medium layer 56 is interposed between display substrates 58a and 58b. In front of the substrate 58a, there is provided a barrier film 60 for protecting the electrophoretic medium layer 56 and the substrates 58a and 58b. These elements form part of a standard electrophoretic display known to those skilled in the art.

The security display assembly 50 further comprises a hologram 54. The hologram 54 is interposed between the barrier film 60 and the display substrate 58a. Thus, in FIG. 5, the hologram 54 is positioned on the observer's side of the image forming layer (i.e. the electrophoretic medium layer 56). As an electrophoretic display usually is a reflective scattering device, the hologram 54 in FIG. 5 is a either a reflective hologram or a transmissive hologram working on the light scattered from the display.

Upon operation of the security display assembly 50, locally diffracted light provided by the hologram 54 will be seen by the observer as a holographic image (as indicated by the holographic view cone 62) superimposed on the display image (as indicated by the dominant display viewing cone 64) provided by the display 52.

Optionally, the security display assembly according to the invention can comprise a holographic brightness improvement layer. This holographic layer or film collects light from all directions and focuses it in specific range and direction, thus increasing the brightness of the display in this range and direction. According to an embodiment of the invention, the holographic brightness improvement layer is integrated with the hologram providing the holographic image. That is, the hologram provides both the holographic image and the brightness improvement function.

The holographic layer preferably increases the brightness of the display in a limited predetermined viewing range, which increases the readability of the display within this viewing range. At the same time, the brightness may be decreased for other angles outside the viewing range, reducing the readability of the display for any onlookers watching the display from outside the viewing range. This is schematically illustrated in FIG. 5, wherein 36 denotes the dominant display viewing cone with increased brightness, 38 denotes the holographic view cone, and 40 denotes areas with low brightness. Any onlooker watching the display from an oblique angle outside the view ranges 36 and 38 thus sees little or no information. Using a holographic layer in this way is particularly advantageous in displays with wide viewing ranges, where the viewing range for security reasons should be limited.

The person skilled in the art realizes that the present invention by no means is limited to the preferred embodiments described above. On the contrary, many modifications and variations are possible within the scope of the appended claims. For example, even though the above examples show a liquid crystal display and an electrophoretic display, respectively, many other types of displays can be used in the security display assembly according to the invention.

1-14. (canceled)

15. A security display assembly (10; 50), comprising:
a display (12; 52) for providing a display image, the display having an electrically driven image forming layer; and
a hologram (14; 54) for providing a holographic image,
wherein said hologram is integrated into the display, said hologram occupies essentially the same or less area as the display, and said hologram is placed in front of the image forming layer of the display.

16. A security display assembly according to claim 15, wherein the display and hologram are aligned, so that the display image and holographic image forms a combined image.

17. A security display assembly according to claim 15, wherein the hologram is positioned proximate to the image forming layer of the display.

18. A security display assembly according to claim 17, wherein the distance between the hologram and the image forming layer of the display is equal to or less than the size of a display element.

19. A security display assembly according to claim 15, further comprising a holographic layer adapted to focus light, which light is incoming towards the layer, in a predetermined range and direction.

20. A security display assembly according to claim 19, wherein said holographic layer is integrated with said hologram.

21. A security display assembly according to claim 15, wherein the display has a dark state and a bright state depending on how an electro-optical switching layer influences light in the display assembly, and wherein the hologram is adapted to interact selectively with said light, so that the visibility of the hologram is increased in one of said states and decreased in another of said states.

22. A display assembly according to claim 21, wherein said hologram is polarization selective.

23. A security display assembly according to claim 15, wherein said display is a reflective display.

24. A security display assembly according to claim 15, wherein said display is a display selected from the group of: a liquid crystal display, an electrophoretic display, an electrochromic display, an electroluminescent display, and an electrowetting display.

25. A security product comprising a security display assembly (10; 50) according to claim 15.

26. A security product according to claim 25, wherein said security product is a smart card (20).
